(19) United States
(12) Patent Application Publication
(10) Pub. No.: US 2026/0211629 A1
(43) Pub. Date: Jul. 23, 2026

(54) SYSTEMS AND METHODS FOR IDENTIFYING SUBJECT MATTER EXPERTS IN A TECHNICAL DOMAIN USING SOFTWARE REPOSITORY ANALYSIS

(71) Applicant: JPMorgan Chase Bank, N.A., New York, NY (US)

(72) Inventors: Sibipaul Pallan, Warrenville, IL (US); Amith Bhat, Dombivli (IN)

(73) Assignee: JPMorgan Chase Bank, N.A., New York, NY (US)

(21) Appl. No.: 19/077,690

(22) Filed: Mar. 12, 2025

(30) Foreign Application Priority Data
Jan. 23, 2025 (IN) 202511005517

(51) Int. Cl. G06F 8/30

(52) U.S. Cl. CPC G06F 8/30

(57) ABSTRACT

Aspects of the subject disclosure may include, for example, in a source code management platform, receiving code commits from a group of users resulting in a group of code commits, collecting the group of code commits in a repository, where the group of code commits includes a plurality of methods programmed to implement a plurality of functions, extracting a target method among the plurality of methods in the repository and a target code commit selected from the group of code commits that is associated with the target method, preprocessing the target method and extracting a plurality of features, determining a measurable complexity level of the target method based on a number of linearly independent paths in the target method and generating an impact score of the target code commit for the target method at least based on the extracted plurality of features and the measurable complexity level. The impact score of the target code commit for the target method indicates a per user contribution level by each of the group of users who has contributed to the target method. Other embodiments are disclosed.

### CROSS REFERENCE TO RELATED APPLICATIONS

This application claims priority to Indian Patent Application Serial No. 202511005517 filed on Jan. 23, 2025. All sections of the aforementioned application are incorporated herein by reference in their entirety.

### FIELD OF THE DISCLOSURE

The subject disclosure relates to systems and methods for identifying subject matter experts in a technical domain using software repository analysis.

### BACKGROUND

As technologies become complicated and changing, it is important to identify and maintain a pool of subject matter experts on particular aspects of technologies. Subject matter experts enable projects based on technologies to move along with their experience and knowledge. However, it is possible that knowledge may be centralized within a few team members who are considered as subject matter experts. Also, such subject matter experts may depart and move out of a team or a company. Manual tracking of an individual contributor's areas of expertise may not be effective and efficient. There is a need for an objective, automated system to track and analyze code contributions, identify skill sets, and map developer expertise based on their code commits in a software repository. It is necessary to provide a more accurate and dynamic record-keeping method for mapping developer skills to project contributions, thereby improving talent allocation, collaboration, and overall project efficiency within technical organizations.

### SUMMARY OF THE DISCLOSURE

The subject disclosure describes, among other things, illustrative embodiments for systems and methods for identifying subject matter experts in a technical domain using software repository analysis. For instance, the systems and methods may trace code commits regarding method calls related to the particular functions and identify contribution to the traced method calls by each developer. Data gathered by the systems and methods can be used for more statistical analysis.

The systems and methods provide an innovative software solution acting as a key repository for recording organizational code contributions and mapping developer expertise. By ingesting code data from source code management platforms, the systems and methods generate an expertise score for each developer in real-time. The systems and methods track code similarity of committed code by each user with an existing company codebase, by applying a cosine similarity algorithm to the code commits. The cosine similarity algorithm helps in identifying patterns and similarities in coding styles. By analyzing these similarity scores, the system can determine a team of developers who tend to write similar code, thereby facilitating more cohesive and efficient collaboration within the development team. Accordingly, the systems and methods may facilitate an automated, dynamic record-keeping system for mapping developer skills to project contributions, which is a transformative approach to traditional and manual skill profiling. By streamlining human resource processes and discovering subject matter experts, the systems and methods can change how technical organizations manage their technology talents. Other embodiments are described in the subject disclosure.

One or more aspects of the subject disclosure include are directed to a device including a processing system having a processor and a memory that stores executable instructions that, when executed by the processing system, facilitate performance of operations. The operations include, in a source code management platform, receiving code commits from a group of users resulting in a group of code commits; collecting the group of code commits in a repository, wherein the group of code commits includes a plurality of methods programmed to implement a plurality of functions; extracting a target method among the plurality of methods in the repository and a target code commit selected from the group of code commits that is associated with the target method; preprocessing the target method and extracting a plurality of features; determining a measurable complexity level of the target method based on a number of linearly independent paths in the target method; and using an artificial intelligence/machine learning (AI/ML) model, generating an impact score of the target code commit for the target method as an output of the AI/ML model, at least based on the measurable complexity level of the target method and the extracted plurality of features as an input to the AI/ML model, wherein the impact score of the target code commit for the target method indicates a per user contribution level by each of the group of users who has contributed to the target method.

One or more aspects of the subject disclosure are directed to a non-transitory machine-readable medium, comprising executable instructions that, when executed by a processing system including a processor, facilitate performance of operations. The operations include, in a version control repository, storing source code snippets committed by developers; determining a similarity level of every incoming source code snippet to the stored source code snippets; establishing a code commit log that tracks the committing of the source code snippets along with a timestamp of the code committing, the similarity level and a modification history to the stored source code snippets; extracting a target source code from the code commit log; determining a measurable complexity metric of the target source code based on a number of linearly independent paths in the target source code and using an artificial intelligence/machine learning (AI/ML) model, generating a score of the target source code as an output of the AI/ML model based on a plurality of features as an input to the AI/ML model, wherein the plurality of features includes a call frequency of the target source code, a number of target source code modification, a number of target source code update, the measurable complexity metric of the target source code, or a combination thereof

One or more aspects of the subject disclosure are directed to a method including in a version control repository, storing, by a processing system including a processor, source code snippets committed by developers; determining, by the processing system, a similarity level of every incoming source code snippet to each of the stored source code snippets; maintaining, by the processing system, a code commit log that tracks the committing of the source code snippets along with a timestamp, the similarity level and a modification history for each source code snippet; training, by the processing system, a supervised learning model with labeled data including previously committed source code snippets and associated scores; extracting, by the processing system, a target source code from the code commit log; determining a measurable complexity metric of the target source code based on a number of linearly independent paths in the target source code and using the trained supervised learning model, generating, by the processing system, a score of the target source code as an output of the trained supervised learning model based on a plurality of features as an input to the trained supervised learning model, wherein the plurality of features includes a call frequency of the target source code, a number of target source code modification, a number of target source code update, the measurable complexity metric of the target source code, or a combination thereof.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a system for tracking and determining code submissions of particular functions in accordance with various aspects described herein.

FIG. 2 is another block diagram illustrating an exemplary, non-limiting embodiment of a system for tracking and determining code submissions of particular functions in accordance with various aspects described herein.

FIG. 3 illustrate an exemplary, non-limiting embodiment of user interface resulting from the system of FIG. 1 in accordance with various aspects described herein.

FIG. 4 illustrate an exemplary, non-limiting embodiment of another user interface resulting from the system of FIG. 1 in accordance with various aspects described herein.

FIG. 5 illustrate an exemplary, non-limiting embodiment of yet another user interface resulting from the system of FIG. 1 in accordance with various aspects described herein.

FIG. 6 depicts an illustrative embodiment of a method in accordance with various aspects described herein.

FIG. 7 depicts an illustrative embodiment of another method in accordance with various aspects described herein.

FIG. 8 depicts an illustrative embodiment of yet another method in accordance with various aspects described herein.

FIG. 9 depicts an illustrative embodiment of further another method in accordance with various aspects described herein.

FIG. 10 is a block diagram of an example, non-limiting embodiment of a computing environment in accordance with various aspects described herein.

### DETAILED DESCRIPTION

The subject disclosure describes, among other things, illustrative embodiments for systems and methods for identifying subject matter experts in a technical domain using software repository analysis. For instance, the systems and methods may trace code commits regarding method calls related to the particular functions and identify contribution to the traced method calls by each developer. Data gathered by the systems and methods can be used for more statistical analysis.

The systems and methods provide an innovative software solution acting as a key repository for recording organizational code contributions and mapping developer expertise. By ingesting code data from source code management platforms, the systems and methods generate an expertise score for each developer in real-time. The systems and methods track code similarity of committed code by each user with an existing company codebase, by applying a cosine similarity algorithm to the code commits. The cosine similarity algorithm helps in identifying patterns and similarities in coding styles. By analyzing these similarity scores, the system can determine a team of developers who tend to write similar code, thereby facilitating more cohesive and efficient collaboration within the development team. Accordingly, the systems and methods may facilitate an automated, dynamic record-keeping system for mapping developer skills to project contributions, which is a transformative approach to traditional and manual skill profiling. By streamlining human resource processes and discovering subject matter experts, the systems and methods can change how technical organizations manage their technology talents. Other embodiments are described in the subject disclosure.

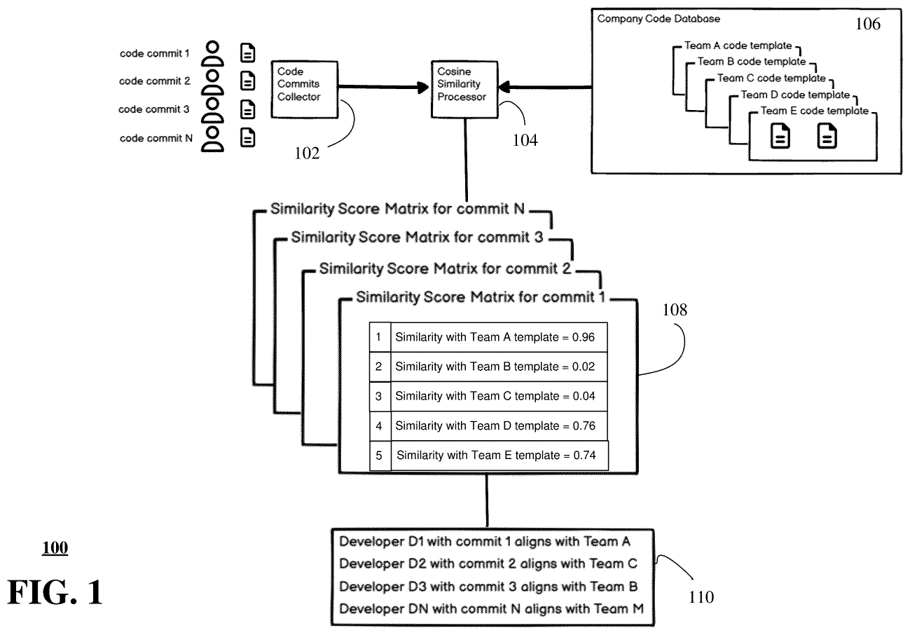

FIG. 1 is a block diagram illustrating an exemplary, non-limiting embodiment of a system 100 for tracking and determining code submissions of particular functions in accordance with various aspects described herein. The system 100 operates in an organization having various engineering teams to execute technical projects. In engineering teams, understanding each individual's strengths and weaknesses is crucial. Analyzing previous commit history by team members (on open-source projects or previous works) can help identify skill gaps and areas of proficiency.

In various embodiments, the system 100 includes a plurality of code commits by developers, such as code commit 1 by Developer D₁, code commit 2 by Developer D₂, code commit 3 by Developer D₃, and code commit N by Developer D_{N}.

In various embodiments, the plurality of code commits are collected in a code commits collector 102. The code commits collector 102 is implemented as a source-code management platform. The code commits collector 102 may operate as a version control system which tracks and saves different versions of source code.

In various embodiments, the collected code commits are provided to a cosine similarity processor 104. The cosine similarity processor 104 accesses company code database 106 structured to store a plurality of different code templates associated with different teams within the organization. Cosine similarity measures the similarity between two vectors of an inner product space. It is measured by the cosine of the angle between two vectors and determines whether two vectors are pointing in roughly the same direction. It is often used to measure document similarity in text analysis. Each word is assigned a different coordinate and a document is represented by the vector of the numbers of occurrences of each word in the document. Cosine similarity then gives a useful measure of how similar two documents are likely to be, in terms of their subject matter, and independently of the length of the documents.

One advantage of cosine similarity is its low complexity, especially for sparse vectors. If the cosine similarity is 1, it means the vectors have the same direction and are perfectly similar. If the cosine similarity is 0, it means the vectors are perpendicular to each other and have no similarity. If the cosine similarity is −1, it means the vectors have opposite directions and are perfectly dissimilar. In text analysis, cosine similarity is used to measure the similarity between document vectors, where each document is represented as a vector in a high-dimensional space, with each dimension corresponding to a term or word in the corpus. By calculating the cosine similarity between document vectors, it is possible to determine how similar or dissimilar two documents are to each other. The cosine similarity algorithm helps in identifying patterns and similarities in coding styles. By analyzing these similarity scores, the system 100 can determine a team of developers who tend to write similar code, thereby facilitating more cohesive and efficient collaboration within the development team. This approach not only enhances understanding of individual contributions but also optimizes team dynamics by aligning developers with complementary coding practices.

As depicted in FIG. 1, the company code database 106 stores code templates for Team A through Team E. Different teams focus on different subject matter, different functionalities, different methods, etc. The code templates represent each focus by different teams. The code templates are provided to the cosine similarity processor 104 to be compared with the plurality of code commits. The cosine similarity processor 104 is operable to process the plurality of code commits and the code templates and generate similarity scores 108. With respect to each code commit, the code similarity score is generated for the code templates stored in the company code database 106. For instance, with respect to the code commit 1, different similarity scores are generated by the cosine similarity processor 104, such as similarity with Team A template=0.96, similarity with Team C template=0.04, as depicted in FIG. 1. The similarity scores clearly indicate that the code commit 1 is directed to or related to Team A template and not related to Team C template.

By using the similarity scores generated by the cosine similarity processor 104, the code commits by different developers can be associated with the code templates of different teams (shown as 110). Such association indicates which developers have contributed in terms of the amount of code submissions and subject matters of code submissions.

In various embodiments, the system 100 is configured to be used in the organization such as consulting companies with wide-ranging clients which can benefit from this process. For well-established projects with numerous contributors, analyzing code commits can help drive talent allocation. With clear visibility into areas of competence, core maintainers can assign relevant issues to contributors skilled in those areas. Analyzing commit histories can help project managers to distribute tasks evenly. Also, identifying key contributors to a piece of code can improve the process of peer reviews. Code commit data are analyzed to devise a skill matrix of their resources, which can help in optimally assigning developers to projects. This also helps in identifying knowledge sharing opportunities. As depicted in FIG. 1, Developer D₁ with code commit 1 will likely be considered as a better fit in Team A for future projects, etc., keeping aside his existing team. By analyzing code commits of junior developers, companies or training institutes can identify common problem areas or knowledge gaps. Training or mentorship programs can be designed, using the system 100, to focus on these areas. In executing large projects, it becomes essential to ensure that resources are being used efficiently. By analyzing commit history, managers can identify if certain developers are being overburdened and accordingly redistribute the workload.

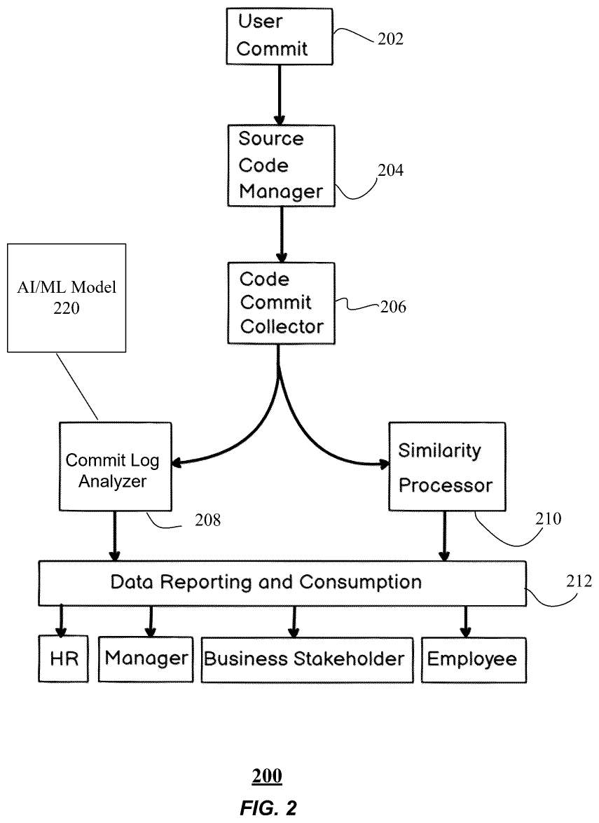

FIG. 2 is another block diagram illustrating an exemplary, non-limiting embodiment of a system 200 for tracking and determining code submissions of particular functions in accordance with various aspects described herein. In various embodiments, the system 200 includes code committing by a group of users (202). In the code committing, for instance, users write, using a particular programming language (e.g., python), a particular function, a basic statement, adds function parameters, update the statement, etc. The group of users collaborate as a team and have simultaneous access to codes that are being written or modified by different users in the group. This allows each user to simultaneously write more lines of code on functions, statements, etc. on top of a current version of code in progress. Code committed by a group of users are provided to a source code manager 204. For instance, the source code manager 204 is a software application configured to keep track of contribution by each user (e.g., a number of lines of code).

In various embodiments, the source code manager 204 keeps track of code committed by different users and determines contribution by each user using certain criteria, such as raw score. As one example, the source code manager 204 may determine the contribution by each user by tracking a number of lines of code written by each user. By way of example only, using a simple case, a first user writes a placeholder function in two lines of code, and adds a basic statement in one line of code. Then a score for the first user is: Committer 1=3. A second user adds a function parameter to the basic statement and updates the basic statement which has been written by the first user. A raw score for the second user is: Committer 2=2. A third user adds a second function parameter to and updates the modified basic statement by the second user. A raw score for the third user is: Committer 3=2. The first user adds two default values for the two parameters added by the second user and the third user, respectively. So the raw score for the first user becomes: Committer 1=5. In the above simple case, final scores for the first, the second and the third users are: Committer 1=55.56 (5/9 lines of code), Committer2=22.22 (2/9 lines of code), and Committer3=22.22 (2/9 lines of code). The simple case described above is for convenience of description and actual applications are much more complex and involve significantly larger codebases and complexity. In the above example, the raw score is provided as a simple example, based on an amount of contribution by each user, and as will be described below, scoring may represent more attributes of users'contribution by reflecting importance or impact of methods or functions generated or modified by each user, etc. in an overall project. In practical applications, it is important to determine an impact of a code commit by understanding the impact of changes brought by the code commit: for instance, a 1 line change may be assigned with a bigger impact score than a 10 line change in light of an overall impact.

In various embodiments, the source code manager 204 provides the committed code to a code commit collector 206 which is a code repository or a code storage. For instance, the code commit collector 206 is implemented to be a code versioning system such that code snippets stored in the code commit collector 206 include associated code versions. By way of example only, the code commit collector 206 may be considered to use code versioning systems that are available in the pertinent art. These code versioning systems operate to track versions of files as a distributed version control system (e.g., cloud based), which facilitate developing software collaboratively by many different programmers.

In various embodiments, the code commit collector 206 maintains a code commit log. Alternatively, or additionally, the source code manager 204 may establish or maintain the commit log at the time that users commit code (202). The code commit log may record the code committing including modifications or changes to the committed code, timestamps associated with the code committing, developers/users who have committed code, etc. The commit log analyzer 208 is configured to keep track of, in the code commit log, contribution by each user (e.g., a number of lines of code), details on the contribution by each user (e.g., writing particular, different functions, modification on core functionality, user interface, fixing bugs, adding new features, etc.), details on contribution types (non-code contribution such as comments, READMEs, logging statements), scores for each user based on their contribution, etc. The code commit collector 206 is accessed by a commit log analyzer 208 and a similarity processor 210.

In various embodiments, the commit log analyzer 208 may analyze the code commit log. For instance, the commit log analyzer 208 analyzes the code commit log at a method level code commit. This allows the commit log analyzer 208 to fetch a history of specific methods or functions. By way of example, the commit log analyzer 208 is configured to track Committer 1 writing Function A, Committer 2 writing Function B, Committer 3 editing and modifying Function A, Committer 4 editing and modifying Function B, etc. The commit log analyzer 208 can navigate changes to specific methods or functions over time. For instance, the changes to specific methods or functions include modifications, renaming, relocation between files and directories, etc. For the navigation of the changes, the commit log analyzer 208 analyzes the detailed log of changes. Based on the detailed log of changes, the commit log analyzer 208 can extract the method or function changes along with timestamps associated with each different change to the method or function and committer details (e.g., which user makes what changes to which part of code, etc.).

In various embodiments, the commit log analyzer 208 may use a Callgraph tool to derive caller-callee relations. Using the Callgraph tool, graphs are generated which reveal relationships between methods and a table indicative of caller-callee relationships is derived based on the graphs. The graphs and the table may provide a more dynamic view of method calls used across classes defined in a particular aspect of an entire code project or throughout the entire code project.

In various embodiments, the data obtained by the commit log analyzer 208, such as the graphs, the table, the code commit log, etc. may be transformed into a format suitable for further analysis (i.e., preprocessing). This transformation may require additional parsing, feature extraction and data cleansing steps. For instance, the extracted features include a number of method calls, a frequency of method calls, a history of method modifications, etc. More specifically, the extracted features are further described using the following example. Developer1 creates a function that initializes and returns a result list without iteration, earning a score of 3 based on the lines of code. Developer2 then introduces a while loop using a currentIndex variable, iterating until the currentIndex variable reaches 50. This modification adds five lines of code, and since the loop executes 50 times, Developer2 receives an impact score of 250. Developer2 also integrates a library function developed by Developer3, adding one line of code. When Developer3 modifies this library function, it impacts the loop's execution 50 times, giving Developer 3 an impact score of 50. Developer2's total score is updated to 301, accounting for previous changes and the integration. This example illustrates how scores can be calculated by considering both the lines of code and the frequency of execution.

In various embodiments, the transformed or preprocessed data may be processed through artificial intelligence/machine learning (AI/ML) models to evaluate an impact of each method upon determining contribution per each method and/or per developer(s) who have written or modified each method. The AI/ML model may consider features like the frequency and context of method calls, code complexity, how often the method has been updated/modified, among other features, to generate a result (e.g., a score) indicative of the method's impact. The result such as scores are aggregated per method or developer to derive overall contributions. This can be done using various methodologies, such as sum, average, or any other relevant statistical measures. A broad view of the contribution of each developer or the importance of each method in an overall project can be provided.

In various embodiments, the system 200 includes a similarity processor 210 operable to access the code commit collector 206 and retrieve code snippets. The similarity processor 210 preprocesses the retrieved code snippets by removing comments, whitespaces, etc. The similarity processor 210 further performs variable renaming to normalize code. The similarity processor 210 transforms the pre-processed code snippets into numerical vectors and compare the numerical vectors against numerical vectors generated for any existing code snippets.

In various embodiments, the similarity processor 210 is configured as a cosine similarity processor, as described above in connection with FIG. 1. The similarity processor 210 computes cosine similarity. By way of example only, cosine similarity function from available open-source library may be used. Cosine similarity between a new code snippet and every other snippet in the code commit collector 206 is calculated. The similarity will be between zero (entirely dissimilar) and 1 (entirely similar). Results are aggregated and can be presented to users. The cosine similarity of the new code snippet against each existing snippet from the code commit collector 206 is computed and aggregated. Similarity associated with code snippets such as a particular method or function may be utilized in determining the impact of the particular method or function and contribution per the particular method or function or contribution per developers who have written such method or function.

In various embodiments, the commit log analyzer 208 and the similarity processor 210 provide the results and information to a data reporting and consumption platform 212. The platform 212 may analyze the results and information from the commit log analyzer 208 and the similarity processor 210 and provide reports or recommendations to various entities in an organization such as human resources, managers, business stakeholders, employees, etc. For projects with numerous contributors, analyzing code commits can provide clear visibility into areas of competence, assign relevant issues to contributors skilled in those areas, etc. Also, identifying key contributors to a piece of code can improve the process of peer reviews. Analyzing commit histories can help project managers to distribute tasks evenly. Code commit data are analyzed to devise a skill matrix of their resources, which can help in optimally assigning developers to projects. By analyzing commit history, managers can identify if certain developers are being overburdened and accordingly redistribute the workload.

In various embodiments, one or more AI/ML model 220 may be used in refining various aspects of the system 200. For instance, the AI/ML model 220 can be used in refining the scoring system based on code commits. The AI/ML model 220 may classify code updates based on a level of impact associated with the code updates. For instance, the level of impact associated with the code updates may be classified as high, medium, or low. This classification can be based on areas of code changed, a type of change, a nature of code, etc. As one example, the areas of code changes include core functionality, user interface, etc. As another example, the type of changes includes adding new feature(s), fixing bug(s), refactoring, etc. The nature of code may involve logic change, comments, logging, etc.

Additionally, or alternatively, differentiating between code and non-code contribution can be done by using the AI/ML models. Contribution may vary depending on writing code, writing non-code elements like writing comments embedded in the written code, modifying READMEs, adding logging statements, etc.

In various embodiments, the AI/ML model 220 may be applied to evaluate code complexity. In FIG. 2, the AI/ML model 220 is configured to apply to the commit log analyzer 208, but the present disclosure is not limited thereto. The AI/ML model 220 may be applied to the source code manager 204 and be used to evaluate the code complexity. For instance, the AI/ML model 220 may adopt a supervised learning model which requires labeled data. As one example, labeled data include previous commits along with a score given to the previous commits, either manually or through a heuristic determination. The features used for the supervised learning model include, without limited to, a number of lines of code changed, a number of functions/methods changed, measurable complexity of the code (e.g., using Cyclomatic complexity or similar metrics), whether the code commit is associated with fixing bug(s) (e.g., potentially identified through linked issue trackers), a type of file that was changed (e.g., source code, test code, documentation, etc.).

Cyclomatic complexity (CYC) is a software metric that measures the complexity of a program by counting the number of linearly independent paths through its source code. Cyclomatic complexity is used to indicate how difficult a program may be to test, maintain, troubleshoot, or produce errors. A higher cyclomatic complexity indicates more complexity in the code. A lower number generally indicates that programs are easier to understand and less risky to modify. High cyclomatic complexity does not necessarily mean there is a problem. Other features, such as the context in which the code is used, should be considered. Cyclomatic complexity can help identify problematic code. Monitoring cyclomatic complexity can help identify areas of code that are potentially problematic or overly complex. Additionally, cyclomatic complexity can be calculated by counting nodes and edges. Nodes are individual commands or statements, and edges connect nodes. Simplifying conditional logic can help reduce complexity. Minimizing branching makes code's behavior more predictable and flow more intuitive.

In various embodiments, after evaluating the code complexity using the supervised learning model, a regression technique may be utilized to predict an impact score of a particular commit, such as Linear Regression, Decision Trees, Random Forest Regressor, or Support Vector Regressor. The regression technique is a supervised machine learning technique which is used to predict continuous values. The regression technique describes how to numerically relate an independent variable (e.g., code snippets) to the dependent variable (e.g., scores). In various embodiments, using the features described above, such as a number of lines of code changed, a number of functions/methods changed, measurable complexity of the code, etc., the AI/ML model is trained to learn the relationship between these features and the assigned impact score. Then, in response to a new code commit input, the AI/ML model may predict an impact score of the new code commit based on the learning. Accordingly, the AI/ML model enables learning significance of content without requiring manual rule updates by managers. For instance, linear regression aims to model the relationship between two variables by fitting a linear equation to observed data. Decision tree regression is a model that predicts numeral values using a tree-like structure which splits data based on key features, starting from a root question to branching out. Random forest regression uses an ensemble learning method for regression in machine learning, where trees run in parallel and there is no interaction between these trees while building the trees. Support vector regression is an extension of Support Vector Machines (SVM) that can be used to solve regression problems where a function is optimized by finding a tube that approximates a continuous-valued function while minimizing the prediction error.

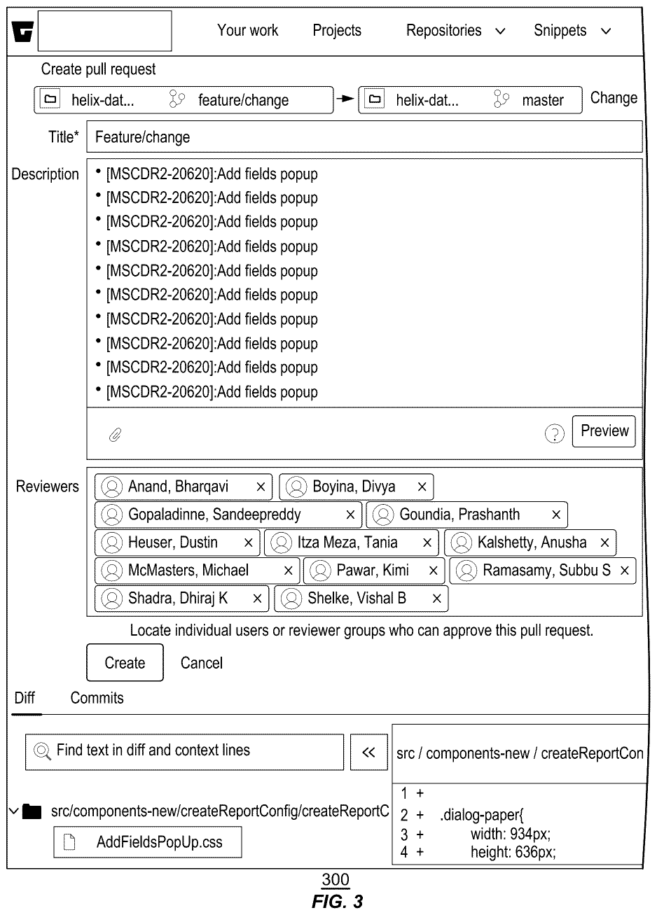

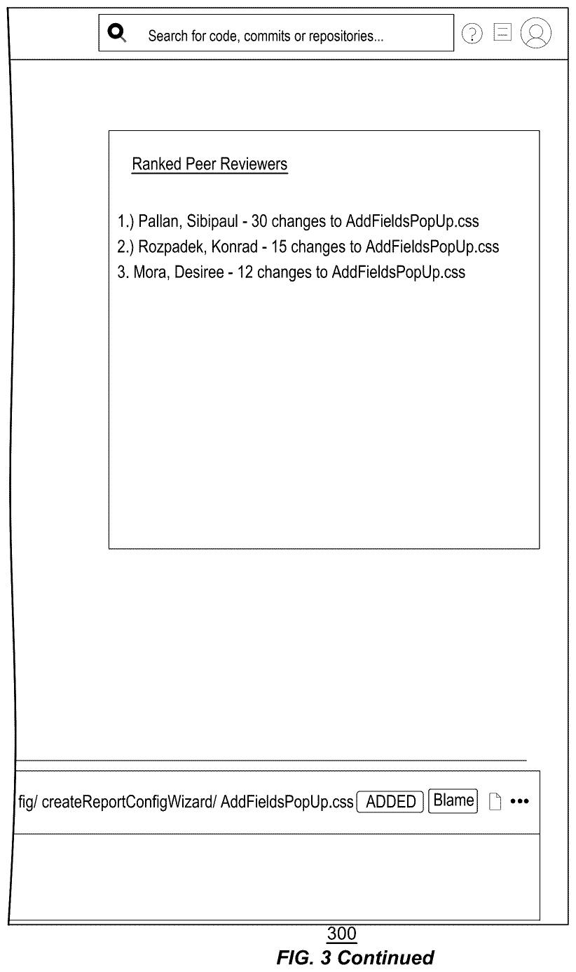

FIG. 3 illustrate an exemplary, non-limiting embodiment of user interface 300 resulting from the system of FIG. 1 in accordance with various aspects described herein. The user interface 300 illustrates an example of “Create pull request” and corresponding descriptions and reviewers. As one example, the user interface 300 depicts “Ranked Peer Reviewers” along with a number of changes to a particular piece of code.

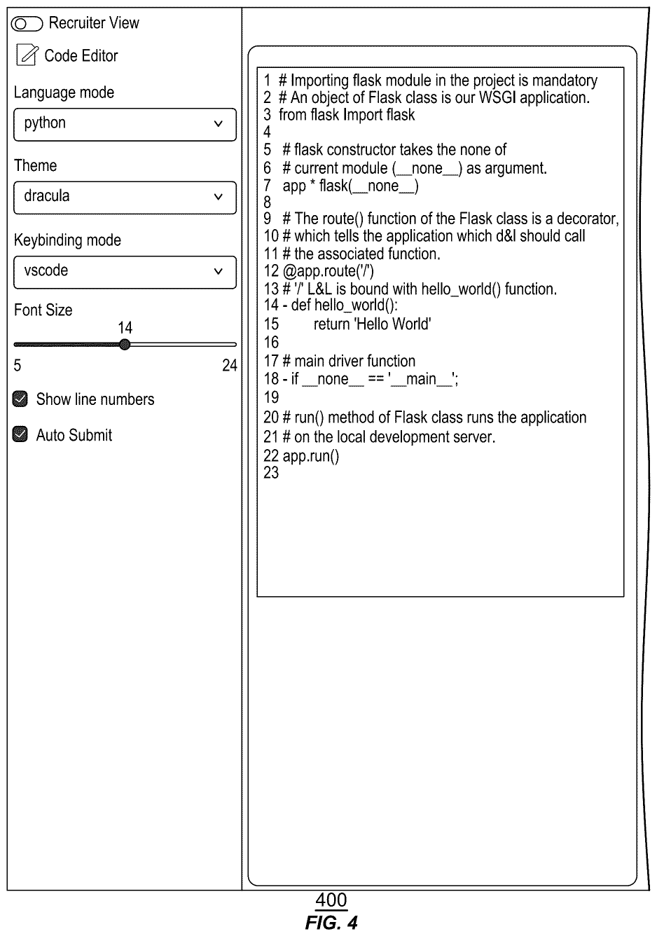

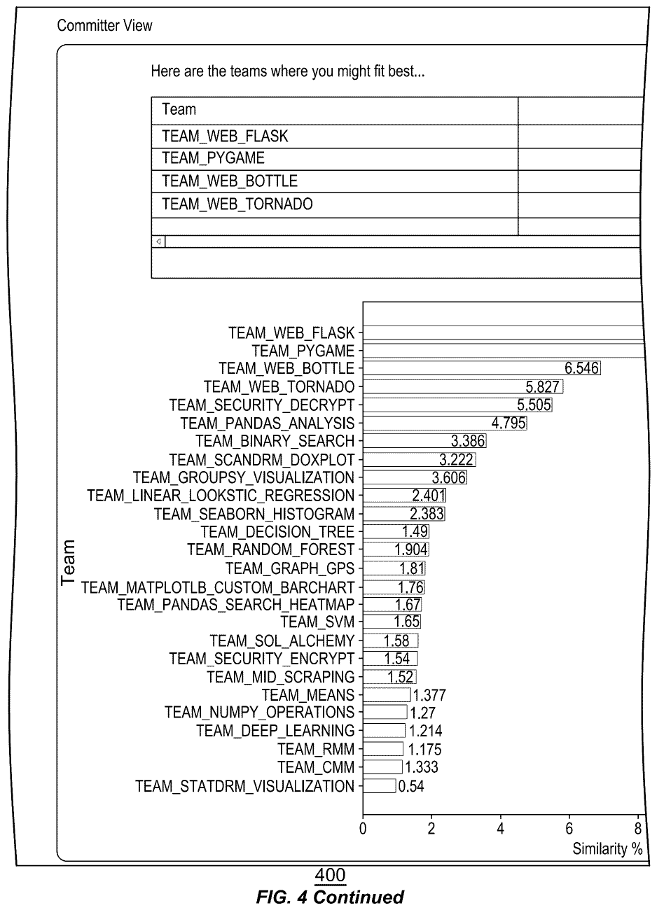

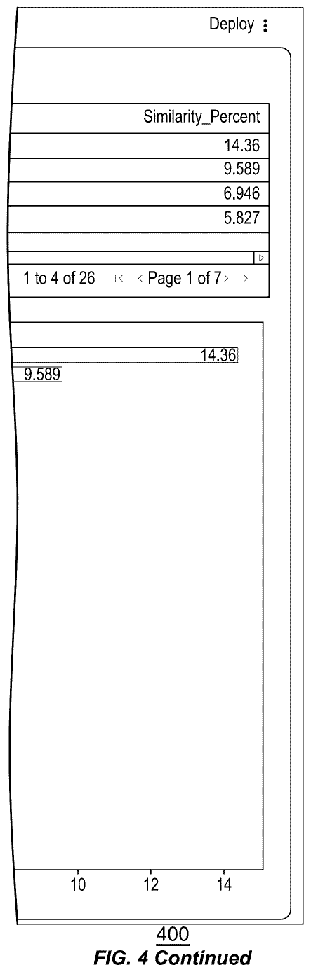

FIG. 4 illustrate an exemplary, non-limiting embodiment of another user interface 400 resulting from the system of FIG. 1 in accordance with various aspects described herein. As one example, the user interface 400 depicts “Committer View” which include different teams and their focuses. The user interface 400 depicts a particular code snippet. The user interface 400 may guide a committer to identify a team in which the committee can be the best fit with respect to the subject matter of the particular code snippet.

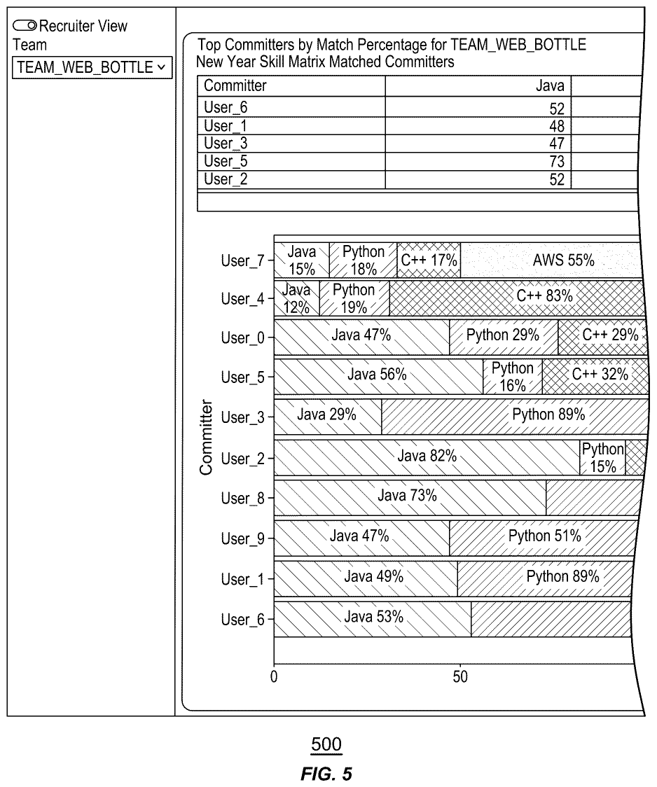

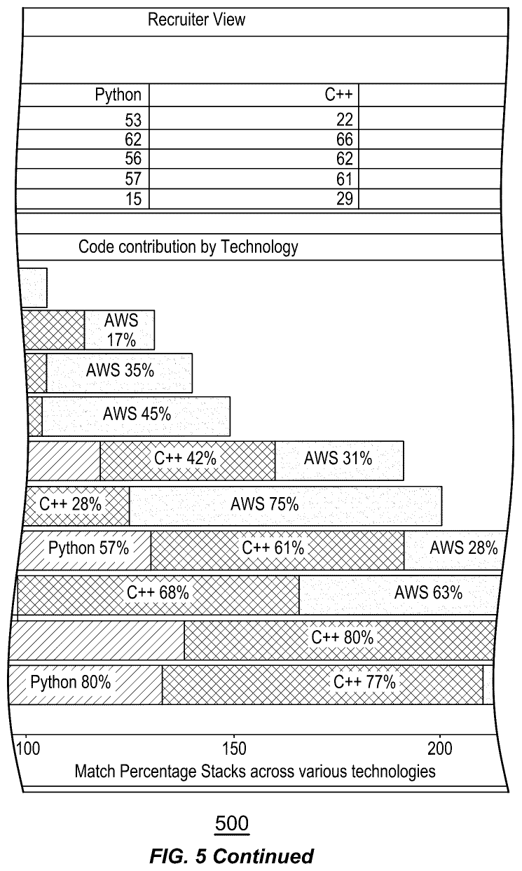

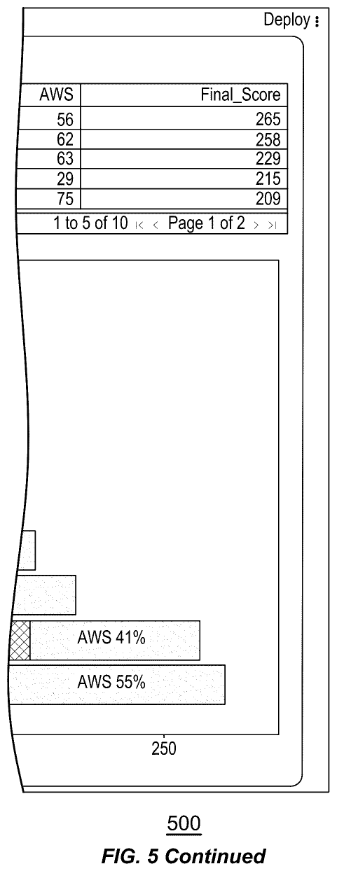

FIG. 5 illustrate an exemplary, non-limiting embodiment of yet another user interface 500 resulting from the system of FIG. 1 in accordance with various aspects described herein. The user interface 500 depicts “Recruiter View” which shows top committers with respect to a particular team. The user interface 500 further includes color coding of code contribution by programming language. For instance, color coding may correspond to percentage of code contribution.

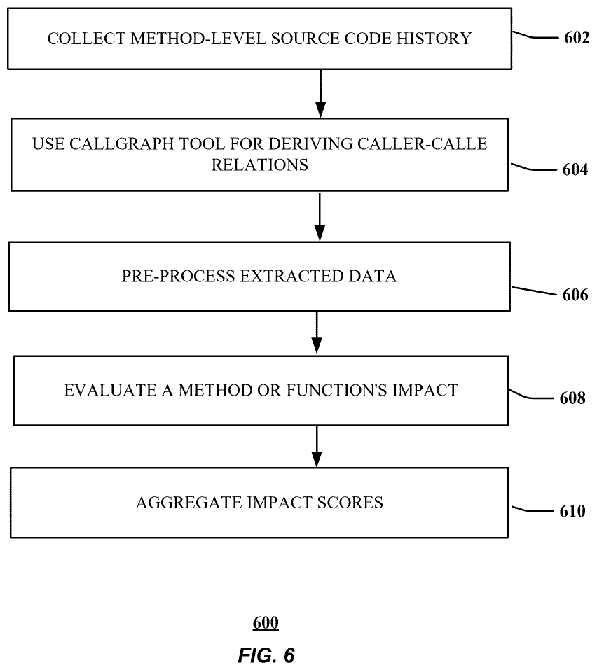

FIG. 6 depicts an illustrative embodiment of a method 600 for tracking and determining code submission of a particular method or function in accordance with various aspects described herein. In various embodiments, the method 600 includes collecting a method-level source code history (Step 602). The history of the particular method or function is fetched. The particular method or function has changed over time (e.g., modifications, renames, relocation between files and directories), and such change can be navigated. For that purpose, a detailed log of changes is generated and maintained, as described above in connection with FIG. 2. For example, the method-level source code history may include a detailed log of changes. From this complex log of data, the detailed log of changes may include timestamps and code committer details related to the changes.

The method 600 further includes using a Callgraph tool for deriving caller-callee relations (Step 604). The Callgraph tool can be used to extract the features such as a number of method calls and a frequency of method calls. The Callgraph tool is a visual representation of the calling relationships between subroutines or functions in a program. These tools analyze the source code or runtime behavior of a program to construct the graph, which can then be used for various purposes such as Code Analysis for understanding the structure and flow of a program, performance optimization for identifying bottlenecks or frequently called functions, debugging for tracing the execution path to locate errors or unexpected behavior, and refactoring for identifying tightly coupled components or redundant code. Using the Callgraph tool, graphs are generated to determine relationships between methods or functions and derive a table of caller-callee relationships. As described above, a more dynamic view of method calls used across classes can be provided.

The method 600 includes pre-processing extracted data (Step 606). The data obtained from the Callgraph tool needs to be transformed into a format suitable for further analysis. This may involve additional parsing, feature extraction and data cleansing steps. As described above, features that can be used to determine the impact score could include a number of method calls, a frequency of method calls, history of method modifications, and so on.

The method 600 includes evaluating an impact of the particular method or function (Step 608). The preprocessed data may now be processed through a machine learning model to evaluate the impact of the particular method or function. The machine learning model may consider features like a frequency and context of method calls, code complexity, how often the particular method or function was updated/modified, among other features, to generate an impact score of the method's impact. As described above, cyclomatic complexity may be used to measure the complexity of a program by counting the number of linearly independent paths through its source code, as one of the features to be considered by the machine learning model, along with the features like the frequency and context of method calls, etc. in order to determine the impact score. Cyclomatic complexity is used to indicate how difficult a program may be to test, maintain, troubleshoot, or produce errors. A higher cyclomatic complexity indicates more complexity in the code. A lower number generally indicates that programs are easier to understand and less risky to modify.

In various embodiments, after evaluating the code complexity using the supervised learning model, a regression technique may be utilized to predict an impact score of a particular commit, such as Linear Regression, Decision Trees, Random Forest Regressor, or Support Vector Regressor. In various embodiments, using the features described above, such as a number of lines of code changed, a number of functions/methods changed, measurable complexity of the code, etc., the AI/ML model is trained to learn the relationship between these features and the assigned impact score. Then, the trained AI/ML model can be used with a new code commit input (i.e., not training data but new input data such as a new code snippet), and in response to the new code commit input, the AI/ML model may predict an impact score of the new code commit based on the learning. The new code commit input may not be used for training the AI/ML model and is provided as a new input to the trained AI/ML model. Accordingly, the AI/ML model enables learning significance of content without requiring manual rule updates by managers.

The method 600 also includes aggregating impact scores (Step 610). The scores are aggregated per method or developer to derive overall contributions. This could be done using sum, average, or any other relevant statistical measure. For example, a particular method may be collaborated by a few developers. An impact score associated with each developer in order to complete the particular method can be aggregated to derive overall contributions. As another example, one developer has contributed to three different methods and his or her impact score for each method can be aggregated to determine his or her overall contribution. This step 610 will provide a broad view of the contribution of each developer or the importance of each method in the overall project.

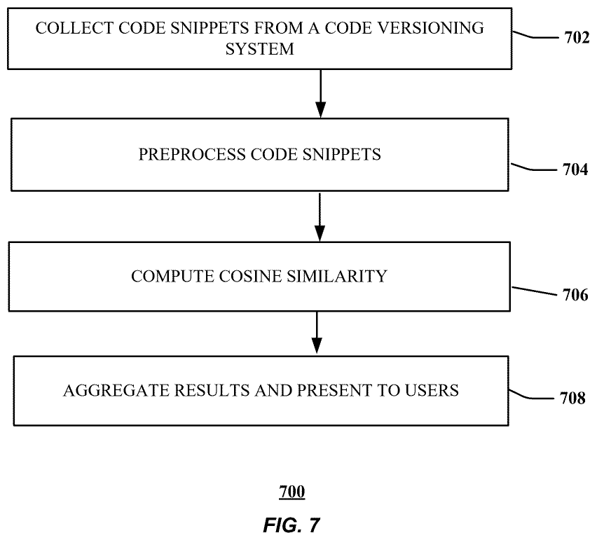

FIG. 7 depicts an illustrative embodiment of a method 700 for determining code similarity level in accordance with various aspects described herein. In various embodiments, the method 700 includes collecting code snippets from a code versioning system (Step 702) and preprocessing the code snippets by removing comments, whitespaces, and performing variable renaming to normalize code (Step 704). The method 700 also includes transforming the code snippets into numerical vectors and comparing the code snippets against numerical vectors generated for any existing file (Step 704).

In various embodiments, the method 700 includes computing cosine similarity (Step 706). By way of example, a cosine_similarity function from the any open-source library may be used. The cosine similarity between the new snippet and every other snippet in our database is calculated and thus, the similarity will be between 0 (entirely dissimilar) and 1 (entirely similar). The method 700 includes aggregating the results and present it to the user (Step 708). The cosine similarity of the new code snippet is calculated against each existing snippet from company code repositories.

FIG. 8 depicts an illustrative embodiment of a method 800 for generating an impact score in accordance with various aspects described herein. In one or more embodiments, method 800 in FIG. 8 builds upon the foundational elements depicted in prior figures by integrating the processes of code commit collection and analysis as shown in FIG. 1 and FIG. 2. For example, method 800 can be adapted to utilize the code commits collector 102 and cosine similarity processor 104 from FIG. 1 to gather and assess code contributions, aligning them with team templates in the company code database 106 to determine developer expertise. Method 800 further refines the analysis by extracting target methods and features from the repository, as outlined in FIG. 2, and employs AI/ML models 220 to generate impact scores as described below, thereby quantifying individual contributions. The user interfaces 300, 400, 500 in FIG. 3, FIG. 4, and FIG. 5 illustrate exemplary applications of these processes, providing visual insights into developer rankings and team alignments based on the computed impact scores.

In various embodiments, the method 800 includes, in a source code management platform, receiving code commits from a group of users (Step 802). In the context of the subject disclosure, “code commits” can refer to the process of submitting changes to a code repository within a source code management platform. Each code commit can represent, for example, a snapshot of modifications, additions, or deletions to the source code, accompanied by metadata such as timestamps, author information, and commit messages from developers. Code commits associated with software code changes can occur, for example, at various stages in its development such as approved for commercial use, approved for internal use, approved for debugging, approved for stress testing, and so forth. Code commits are integral to version control systems, enabling the tracking of code evolution, facilitating collaboration among developers, and serving as a basis for analyzing developer contributions and expertise within a technical domain. In some examples, the code commits from the group of users may result in a group of code commits.

In the context of the subject disclosure, the users submitting and analyzing code commits typically include developers, software engineers, and programmers who are actively involved in the development and maintenance of software projects. These users are responsible for making modifications, additions, or deletions to the source code, which are then submitted as code commits to a repository. Additionally, project managers, team leads, and quality assurance specialists may analyze these code commits to track code evolution, assess developer contributions, and ensure that the code meets project requirements and quality standards. These users utilize the metadata associated with each commit, such as timestamps, author information, and commit messages, to facilitate collaboration, review changes, and manage the software development lifecycle effectively.

Accordingly, a code commit can be a process of submitting changes made to a code repository, which is a centralized storage location for source code and related files. In one or more embodiments, a source code management platform is depicted in FIGS. 1 and 2, such as the system 100 and the system 200. As depicted in FIG. 2, one or more code commits are provided to the code commit collector 206 which is a code repository or a code storage. As depicted in FIG. 1, a plurality of code commits by developers, such as code commit 1 by Developer D₁, code commit 2 by Developer D₂, code commit 3 by Developer D₃, and code commit N by Developer D_{N} can be supplied to the Code Commits Collector 102. In some examples, the group of users may include a group of developers working on a project using a source code management platform. Each developer commits their changes to the repository, as depicted in FIG. 2. For instance, Developer A commits a new feature implementation, Developer B commits a bug fix, and Developer C commits a code refactor.

Method 800 further includes collecting the received code commits in a repository (Step 804). Referring back to FIG. 1, the repository is depicted as part of the code commits collector 102. This component tracks and saves different versions of source code. The repository stores the plurality of code commits made by developers, such as code commit 1 by Developer D11, code commit 2 by Developer D22, and so on. In FIG. 2, the repository is represented by the code commit collector 206. The user interfaces depicted in FIGS. 3-5 illustrate how the repository's data can be utilized for various purposes. The group of code commits may include a plurality of methods programmed to implement a plurality of functions (Step 804). In some examples, each code commit may be associated with a respective method of the plurality of methods. In other examples, each code commit may be associated with more than one method of the plurality of methods. As another example, the source code management platform collects all of the committed code into the repository, as depicted in FIG. 2. As further depicted in FIG. 2, the source code manager 204 provides the committed code to the code commit collector 206 which is a code repository or a code storage. The repository now contains various methods such as calculateInterest( ) (e.g., a function coded to calculate an interest such as for a financial instrument including bonds), processTransaction( ) (e.g., a function coded to process a transaction such as a sale or purchase of a financial instrument including bonds), and generateReport( ) (e.g., a function coded to generate a report such as describing characteristics of or associated with a particular financial instrument, a history associated with the financial instrument including a history of transactions, and so forth), each implementing different functions of the software project.

The method 800 further includes extracting a target method among the plurality of methods in the repository (Step 805). By way of example, from the collected code, the method 800 identifies and extracts the method calculateInterest( ) for further analysis (Step 805). For instance, as depicted in FIGS. 3-5, “Create Pull Request” can be used to identify and extract a particular method. As depicted in FIG. 3, “Search for code, commits or repositories” can be used to extract a particular method. Users such as reviewers, managers, HR personnels, project management teams, etc. can search for a particular code, commits or repositories as needed. In further examples, the method 800 further includes extracting a target code commit selected from the group of code commits that is associated with the target method.

The method 800 also includes preprocessing the extracted target method and extracting a plurality of features (Step 806). For instance, in Step 806, the method 800 preprocesses the calculateInterest( ) method by removing comments and whitespace, normalizing variable names, and then extracting features such as the number of lines of code, the measurable complexity of the target method (e.g., cyclomatic complexity), the number of times it has been called, and the number of modifications it has undergone. For example, the method 800 may further include determining a measurable complexity level of the target method as a feature of the target method based on a number of linearly independent paths in the target method (Step 808).

Then, the method 800 proceeds to generating an impact score of the committed code for the target method at least based on the extracted plurality of features and the measurable complexity level (Step 810). By way of example, the method 800 generates the impact score of the committed code by calculating, for instance, cyclomatic complexity of the calculateInterest( ) method as one of the features (Step 810), along with the features such as the number of lines of code, the complexity of the method, the number of times it has been called, and the number of modifications it has undergone. As mentioned above, cyclomatic complexity is a software metric that measures the complexity of a program by counting the number of linearly independent paths through its source code. By way of example only, cyclomatic complexity is used to indicate how difficult a program may be to test, maintain, troubleshoot, or produce errors. A higher cyclomatic complexity indicates more complexity in the code. The method 800 may find that the extracted target method has a cyclomatic complexity of 15, indicating a relatively high complexity due to multiple conditional statements and loops (Step 810). In this example, the cyclomatic complexity is used for explanation purpose, but as described above, the features such as the number of lines of code, the complexity of the method, the number of times it has been called, and the number of modifications it has undergone can also be considered along with the cyclomatic complexity.

An AI/ML model (such as the AI/ML model 220 depicted in FIG. 2) is used in generating the impact score for the calculateInterest( ) method based on a plurality of extracted features (Step 810). The AI/ML model considers the extracted features and the complexity level to determine that Developer A's recent changes have a high impact score of 85, while Developer B's bug fix has a moderate impact score of 40, and Developer C's refactor has a low impact score of 20. These scores reflect the contribution level of each developer to the calculateInterest( ) method (Step 810). The calculateInterest( ) method is described by way of example only and the method 800 is not limited thereto.

As described above, the cyclomatic complexity value represents the number of linearly independent paths through the program. A linearly independent path is a unique sequence of execution that does not include any other path as a subset. Each path corresponds to a distinct way the program can be executed, considering all possible branches and loops. Linearly independent paths are used to evaluate the complexity of methods and functions within the committed code. For example, in FIG. 8, Step 808 involves determining the measurable complexity level of the target method, which includes calculating its cyclomatic complexity. This step helps in understanding the intricacy of the method by identifying the number of linearly independent paths it contains.

For instance, the calculateInterest( ) method can be characterized by containing multiple conditional statements and loops, which contribute to the formation of linearly independent paths. Conditional statements are programming constructs that allow the method to execute different, unique code paths based on certain conditions or criteria. Loops are constructs that enable the method to repeatedly execute a block of code as long as a specified condition is met, further increasing the number of linearly independent paths by introducing additional execution sequences. Together, these elements suggest that the calculateInterest( ) method is designed to perform complex calculations or operations that require decision-making and iterative processing. Suppose, for example, the cyclomatic complexity of this method is calculated to be 15, indicating that there are 15 linearly independent paths through the method. This high complexity suggests that the method has numerous branches and loops, making it more challenging to test and maintain.

The cyclomatic complexity, and thus the number of linearly independent paths, is one of the features used by the AI/ML model to generate an impact score for the committed code. A higher cyclomatic complexity indicates a more complex method, which may have a higher impact on the overall project. This complexity is factored into the impact score, reflecting the significance of the developer's contribution to the method.

Linearly independent paths, as measured by cyclomatic complexity, provide a quantitative assessment of a program's complexity. This metric is used to evaluate the complexity of methods and functions, contributing to the generation of impact scores for code commits. By understanding the number of linearly independent paths, the system can better assess the difficulty and significance of developers'contributions, ultimately improving talent allocation and project efficiency within technical organizations.

In one or more embodiments, linearly independent paths in a program can refer to unique execution paths that do not include any other path as a subset. These paths assist in understanding the complexity and testing requirements of a software program. A call graph, as depicted in FIG. 6, can be a visual representation of the calling relationships between methods or functions in a software program. For example, a call graph tool can assist in determining that the calculateInterest( ) method/function may call a method getInterestRate ( ) (e.g., a method/function that obtains or determine an interest rate for a transaction), applyDiscount( ) (e.g., a method/function that applies discounts to the interest rate), and/or logTransaction( ) (e.g., a function that logs the transaction). Once each of the methods/functions getInterestRate( ), applyDiscount( ), and logTransaction( ) are identified, each of these methods/functions can be analyzed for the linearly independent paths, as described in the subject disclosure.

By using a call graph tool, one can therefore derive caller-callee relations, which help in identifying these independent paths. The call graph can provide, for example, a dynamic view of method calls across classes, allowing for the extraction of features such as a number of method calls and their frequency. This information can then be used to evaluate the impact of each method or function, as well as to determine the linearly independent paths, which are essential for assessing the complexity and contribution of code commits.

As one example, the determining the measurable complexity level of the target method (Step 808) further includes determining the complexity level of the target method based on cyclomatic complexity. As described above, the cyclomatic complexity is used to indicate how difficult a program may be to test, maintain, troubleshoot, or produce errors, and a higher cyclomatic complexity indicates more complexity in the code.

The method 800 further includes training an artificial intelligence/machine learning (AI/ML) model based on input parameters including a number of changed lines of the committed code, a number of modifications to the committed code, the measurable complexity metric of the committed code, the code committing associated with fixing an error, or a combination thereof. The method 800 also further includes training the AI/ML model based on output parameters including scores assigned to the committed code. By way of example only, the AI/ML model is trained with training datasets such as new feature implementation-a high impact score of 85, bug fix-a moderate impact score of 40, and refactor-a low impact score of 20. Thus, the generating the impact score of the committed code for the target method (Step 810) further includes generating the impact score of the committed code for the target method using the trained AI/ML model. When a new commit code comes in, then the trained AI/ML model may predict an impact score based on the training and what has been learned from the training. The trained AI/ML model may learn significance of the commit code content without requiring manual rule updates by users. Preparing and maintaining labeled data may become increasingly effective over time as more data are fed back into the trained AI/ML model.

In various embodiments, the impact score of the committed code for the target method further indicates a per method contribution level of the target method to an entire project utilizing the target method. For instance, the target method implements key functionality in part or as a whole, which will likely result in a very high ‘per method’ contribution level of the target method to the entire project, as opposed to a common bug fixing. In various embodiments, the method 800 further includes maintaining a code commit log that tracks the committed code along with a timestamp of the code committing and a modification history to the committed code. This enables reviewers and managers to keep track of development works performed by each developer in detail. The method 800 further includes receiving a first code snippet from a first user, using cosine similarity, determining a similarity level between the first code snippet and each of the committed code collected in the repository, and based on the determined similarity level, tracking and classifying contribution of the first code snippet by the first user. By way of example, each distinct part in the first code snippet from the first user is treated individually and their frequency is counted. These counts are converted into vectors and passed to the cosine similarity function. The cosine similarity function calculates a dot product of intersection vectors for any intersection part (e.g., “0” for no intersection part). Then the cosine similarity function calculates a square root of a sum of squares of values from each vector and divides the dot product by the product of the square root values to find the cosine similarity. If cosine similarity returns “0,” the result indicates no similarity between the first code snippet and the committed code in the repository.

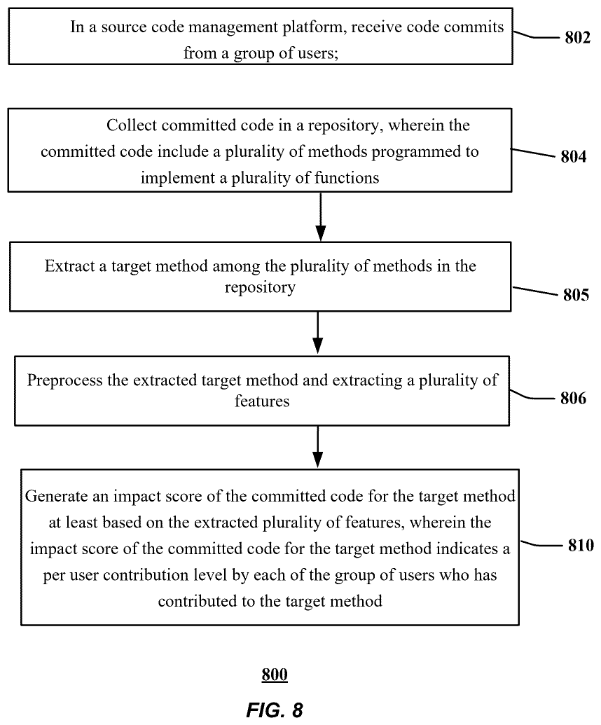

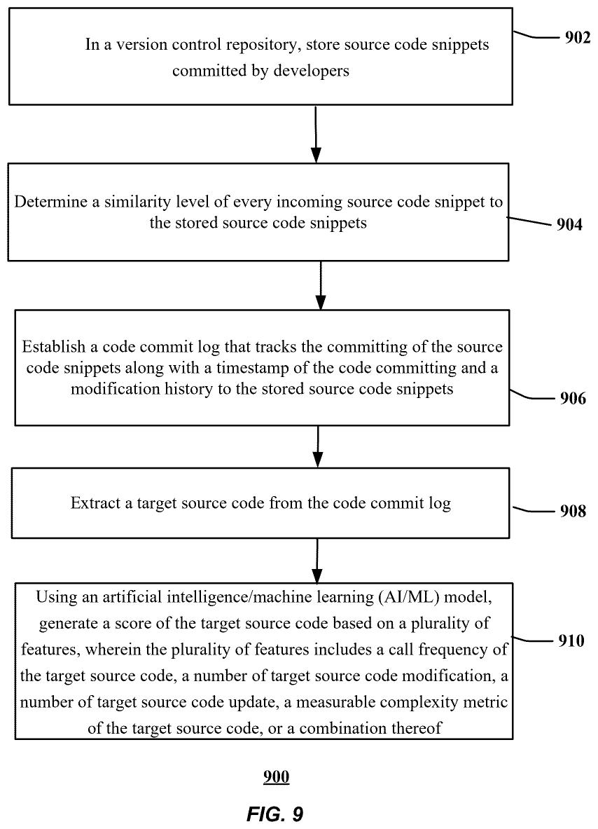

FIG. 9 depicts an illustrative embodiment of a method 900 for determining code similarity level in accordance with various aspects described herein. In one or more embodiments, FIG. 9 relates to the previous figures by detailing the procedural steps involved in the analysis of code commits, as introduced in FIG. 1 and FIG. 2. In FIG. 1, the system 100 is shown collecting code commits and processing them through a cosine similarity processor 104 to generate similarity scores 108, which are then used to align developers with specific team templates in the company code database 106. FIG. 2 expands on this embodiment by illustrating the flow of code commits through various components, including the code commit collector 206 and similarity processor 210, and their subsequent analysis by AI/ML models 220. FIG. 9 further elaborates on these processes by outlining a method 900 for storing source code snippets (902), determining similarity levels (904), and using AI/ML models to generate scores (910) based on features such as call frequency and complexity metrics, thereby providing a comprehensive view of how code commits are analyzed and scored within the system.

Method 900 of FIG. 9 further elaborates on these processes by outlining several steps including, for example,, in a version control repository, storing source code snippets committed by developers (Step 902); determining a similarity level of every incoming source code snippet to the stored source code snippets (Step 904); establishing a code commit log that tracks the committing of the source code snippets along with a timestamp of the code committing, the similarity level and a modification history to the stored source code snippets (Step 906); extracting a target source code from the code commit log (Step 908); and using an artificial intelligence/machine learning (AI/ML) model, generating a score of the target source code based on a plurality of features, wherein the plurality of features includes a call frequency of the target source code, a number of target source code modification, a number of target source code update, a measurable complexity metric of the target source code, or a combination thereof (Step 910).

It will be appreciated that a source code snippet as described above can represent a small, self-contained block of code extracted from a larger codebase (e.g., a subset of larger code commit). It typically represents a specific functionality or logic, such as a method, function, or a segment of a program, and is used to illustrate or implement a particular task or operation. Source code snippets are often used for analysis, sharing, or documentation purposes, allowing developers to focus on specific parts of the code without needing to consider the entire program. In the context of version control systems, these snippets can be compared, modified, and tracked to understand changes and contributions made by developers.

The similarity level, as described in the subject disclosure, can serve multiple purposes in the analysis and management of code commits. It can be used to measure how closely a new code snippet aligns with existing code templates within a company's code database, as shown in FIG. 1, see reference number 106. This measurement helps in identifying which team or project a developer's code style and contributions are most aligned with, facilitating better team assignments and collaboration. In FIG. 2, the similarity processor 210, utilizes this level to provide insights into developer contributions, which can be reported to various stakeholders such as HR, managers, and business stakeholders, as indicated by reference number 212, for informed decision-making. Additionally, as depicted in FIG. 9, the similarity level can be a factor in determining the impact and contribution level of a developer's code, which is further analyzed using AI/ML models, step 910, to generate scores based on features like call frequency and complexity metrics. This comprehensive analysis aids in optimizing resource allocation, enhancing team dynamics, and improving overall project efficiency.

The score described in the subject disclosure can be used as a metric used to evaluate and quantify the impact of code commits within a software project. In FIG. 2, the score is refined through the use of AI/ML models 220, which analyze various features of the code commits collected by the code commit collector 206. The results are then reported to stakeholders such as HR and managers, as shown by reference number 212, to inform decisions on talent allocation and project management. In other embodiments, FIG. 9 elaborates on the scoring process by detailing how an AI/ML model generates a score for a target source code based on features like call frequency and complexity metrics, as indicated by step 910. This comprehensive scoring system enhances the understanding of developer contributions and optimizes resource allocation within technical teams.

In various embodiments, the method 900 further includes determining a contribution level of a developer with respect to the target source code based on the similarity level of a source code snippet committed by the developer to the target source code and the generated score of the target source code. The target source code is a method programmed to run a part of a particular function, and the generating the score of the target source code (Step 910) further comprises generating the score of the target source code based on a frequency of a method call, a number of modifications to the method, a number of updates to the method, a measurable complexity metric of the method, or a combination thereof. The generating the score of the target source code (Step 910) further includes predicting the score of the target source code using the supervised learning model. The method 900 further includes determining a contribution level of the target source code to the particular function based on the generated score of the target source code. For instance, the impact of a code commit or a code change with respect to the existing code may be measured to derive a score for that committer. Sometimes one liner a change to a core functionality can have a far higher impact than a 10 liner change in the same function. Therefore a developer with a one liner change perceived to be more impactful will have higher contribution score compared to another developer who has more lines of code but not as impactful.

In various embodiments, the method 900 further includes determining the measurable complexity metric of the target source code based on labeled data using a supervised learning AI/ML model, where the labeled data comprise previously committed source code snippets and associated scores. The method 900 further includes determining the measurable complexity metric of the target source code based on cyclomatic complexity using a trained supervised learning model. The method 900 further includes receiving non-code contributions by developers, differentiating the non-code contributions from the source code snippet using the supervised learning model, and

assigning different scoring values to the non-code contributions.

In various embodiments, the target source code is programmed to run a part of a particular function. The method 900 further includes determining a contribution level of the target source code to the particular function based on the generated score of the target source code. The method 900 further includes determining a contribution level to the particular function by tracking a number of lines committed to program the particular function by each developer and based on measurable complexity metric of the target source code and a rest of code programmed to run the particular function. The method 900 further includes extracting a modification history of the target source code from the code commit log, and using the supervised learning model, determining, by the processing system, a modification level of the target source code based on a modified part of the target source code, a modified type of the target source code, a nature of the modification, or a combination thereof. The method 900 further includes determining that the modified part of the target source code includes modifying core functionality, determining that the modified type of the target source code includes modifying a new feature, fixing an error, refactoring, or a combination thereof, and determining that the nature of modification includes a logic change, comments, logging or a combination thereof.

While for purposes of simplicity of explanation, the respective processes are shown and described as a series of blocks in FIGS. 6-9, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In the above described embodiments, the systems and methods for tracking and determining code submissions of particular functions may resolve difficulties in identifying and quantifying skills. The systems and methods can provide a platform for identification of teams for internal mobility opportunities purely based on skills, thereby facilitating identification of internal talent with proven track record for recruiting teams.

Data driven decision making during hiring and seeking internal mobility is also provided. The systems and methods facilitate improved talent allocation by identifying developers with skillsets that match team requirements for optimal project assignment. The systems and methods also ensure developers working on projects to be aligned with their expertise, leading to increased efficiency and higher-quality deliverables. Additionally, missing skillsets in teams that need to be addressed can be detected through training or new hires. The systems and methods can enhanced collaboration by bridging a gap between talent and projects, increasing opportunities for cross-departmental collaboration and knowledge sharing. The systems and methods allow better resource management and minimize the risk of over or under-utilizing talent by matching developers'expertise with project requirements.

In the above described embodiments, the systems and methods utilize simpler implementation by using cosine similarity or difflib. Both cosine similarity and difflib are computationally less expensive, making them a more practical choice for many applications, especially when you need real-time results or work with large-scale data. Comparing code snippets or textual data in a binary form (like similarity) can be accurately done with simpler, less resource-intensive methods. Results from cosine similarity and difflib do not depend on the availability of extensive labelled training data.

Alternatively, or additionally, the systems and methods may utilize a deep learning model or large language model (LLM) by using extensive data preparation, tuning, and having a risk of compounding errors during multiple stages of processing.

In the above described embodiments, the systems and methods utilizes a solution that leverages pattern matching, for instance, cosine similarity, to assess developers'skillsets using their code commits. By ingesting code commits as strings and comparing them against a code database from different team(s), the present disclosure aims to facilitate better talent allocation within the teams and improve overall team performance.

Managers can easily identify subject matter experts or a team of subject matter experts relating to a specific functionality within a repository. This will likely allow tasks to be distributed evenly and avoid overload. Subject matter experts can be utilized to provide peer reviews. For instance, a repository can be formed as Java repository but the present disclosure is not limited thereto. For example, a repository dedicated to core banking functionalities in Java, primarily developed by a team of developers—D1, D2,D3, and D4—over several years, may begin to include code for complementary functionalities beyond core banking, such as KYC maintenance and customer portfolio management, created by developers D5, D6, D7, and D8. This positions D1, D2, D3, and D4 as subject matter experts (SMEs) in core banking functionalities, while D5, D6, D7, and D8 become SMEs in non-core banking features. As another example, open source software may be utilized to trace and mine commits which avoid duplicative work. AI/ML techniques can be used to resolve queries to the best subject matter expert in the future.

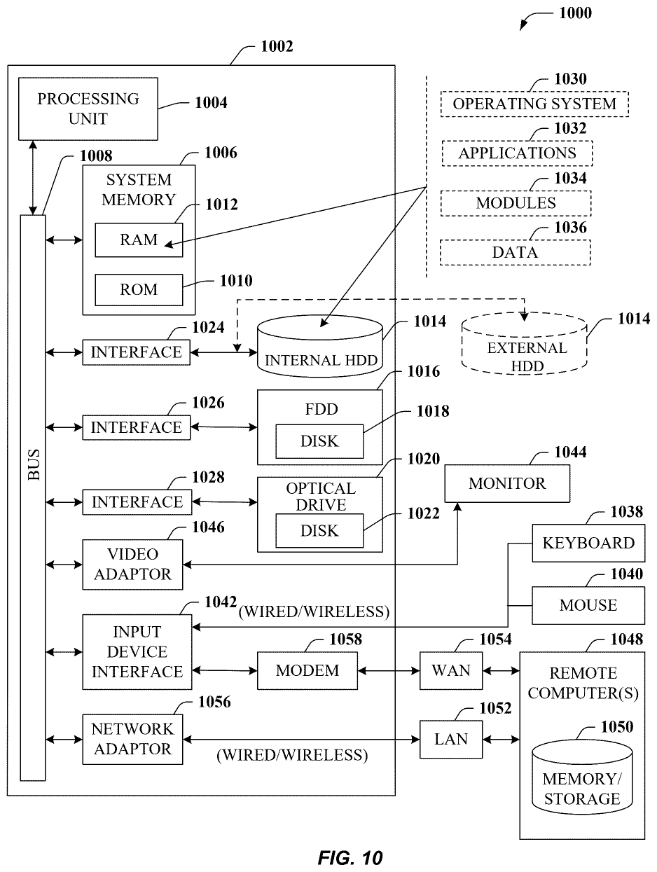

Turning now to FIG. 1000, there is illustrated a block diagram of a computing environment in accordance with various aspects described herein. In order to provide additional context for various embodiments of the embodiments described herein, FIG. 10 and the following discussion are intended to provide a brief, general description of a suitable computing environment 1000 in which the various embodiments of the subject disclosure can be implemented. For example, computing environment 1000 can facilitate in whole or in part systems and methods for identifying subject matter experts in a technical domain using software repository analysis.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 10, the example environment can comprise a computer 1002, the computer 1002 comprising a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multiprocessor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 comprises ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also comprise a high-speed RAM such as static RAM for caching data.

The computer 1002 further comprises an internal hard disk drive (HDD) 1014 (e.g., EIDE, SATA), which internal HDD 1014 can also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high-capacity optical media such as the DVD). The HDD 1014, magnetic FDD 1016 and optical disk drive 1020 can be connected to the system bus 1008 by a hard disk drive interface 1024, a magnetic disk drive interface 1026 and an optical drive interface 1028, respectively. The hard disk drive interface 1024 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 1012, comprising an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) can comprise a microphone, an infrared (IR) remote control, a joystick, a game pad, a stylus pen, touch screen or the like. These and other input devices are often connected to the processing unit 1004 through an input device interface 1042 that can be coupled to the system bus 1008, but can be connected by other interfaces, such as a parallel port, an IEEE 1394 serial port, a game port, a universal serial bus (USB) port, an IR interface, etc.

A monitor 1044 or other type of display device can be also connected to the system bus 1008 via an interface, such as a video adapter 1046. It will also be appreciated that in alternative embodiments, a monitor 1044 can also be any display device (e.g., another computer having a display, a smart phone, a tablet computer, etc.) for receiving display information associated with computer 1002 via any communication means, including via the Internet and cloud-based networks. In addition to the monitor 1044, a computer typically comprises other peripheral output devices (not shown), such as speakers, printers, etc.

The computer 1002 can operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically comprises many or all of the elements described relative to the computer 1002, although, for purposes of brevity, only a remote memory/storage device 1050 is illustrated. The logical connections depicted comprise wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the LAN 1052 through a wired and/or wireless communication network interface or adapter 1056. The adapter 1056 can facilitate wired or wireless communication to the LAN 1052, which can also comprise a wireless AP disposed thereon for communicating with the adapter 1056.

When used in a WAN networking environment, the computer 1002 can comprise a modem 1058 or can be connected to a communications server on the WAN 1054 or has other means for establishing communications over the WAN 1054, such as by way of the Internet. The modem 1058, which can be internal or external and a wired or wireless device, can be connected to the system bus 1008 via the input device interface 1042. In a networked environment, program modules depicted relative to the computer 1002 or portions thereof, can be stored in the remote memory/storage device 1050. It will be appreciated that the network connections shown are example and other means of establishing a communications link between the computers can be used.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
in a source code management platform, receiving code commits from a group of users resulting in a group of code commits;
collecting the group of code commits in a repository, wherein the group of code commits includes a plurality of methods programmed to implement a plurality of functions;
extracting a target method among the plurality of methods in the repository and a target code commit selected from the group of code commits that is associated with the target method;
preprocessing the target method and extracting a plurality of features from the target method;
determining a measurable complexity level of the target method based on a number of linearly independent paths in the target method; and
using an artificial intelligence/machine learning (AI/ML) model, generating an impact score of the target code commit for the target method as an output of the AI/ML model, at least based on the extracted plurality of features and the measurable complexity level as an input to the AI/ML model, wherein the impact score of the target code commit for the target method indicates a per user contribution level by each of the group of users who has contributed to the target method.

2. The device of claim 1, wherein the measurable complexity level of the target method is based on a cyclomatic complexity measurement.

3. The device of claim 2, wherein the operations further comprise:
training the AI/ML model based on input parameters including a number of changed lines of the group of code commits, a number of modifications to the group of code commits, a measurable complexity level of the group of code commits, one or more code commits in the group of code commits associated with fixing an error, or a combination thereof; and
training the AI/ML model based on output parameters including one or more scores assigned to the group of code commits.

4. The device of claim 3, wherein the generating the impact score of the target method further comprise generating the impact score of the target code commit for the target method using the trained AI/ML model.

5. The device of claim 1, wherein the operations further comprise:
determining a contribution score of a first user among each of the group of users, wherein the contribution score includes the generated impact score of the target code commit for the target method and other scores from the group of code commits contributed by the first user.

6. The device of claim 1, wherein the impact score of the target code commit for the target method further indicates a per method contribution level of the target method to an entire project utilizing the target method.

7. The device of claim 1, wherein the operations further comprise:
maintaining a code commit log that tracks the group of code commits with a timestamp and a modification history for each code commit of the group of code commits.

8. The device of claim 1, wherein the operations further comprise:
receiving a first code snippet from a first user;
using cosine similarity, determining a similarity level between the first code snippet and each code commit of the group of code commits collected in the repository; and
based on the determined similarity level, tracking and classifying contribution of the first code snippet by the first user.

9. A non-transitory machine-readable medium, comprising executable instructions that, when executed by a processing system including a processor, facilitate performance of operations, the operations comprising:
in a version control repository, storing source code snippets committed by developers;
determining a similarity level of every incoming source code snippet to the stored source code snippets;
establishing a code commit log that tracks the committing of the source code snippets along with a timestamp of the code committing, the similarity level and a modification history to the stored source code snippets;
extracting a target source code from the code commit log;
determining a measurable complexity metric of the target source code based on a number of linearly independent paths in the target source code; and
using an artificial intelligence/machine learning (AI/ML) model, generating a score of the target source code as an output of the AI/ML model based on a plurality of features as an input to the AI/ML model, wherein the plurality of features includes a call frequency of the target source code, a number of target source code modification, a number of target source code update, the measurable complexity metric of the target source code, or a combination thereof.

10. The non-transitory machine-readable medium of claim 9, wherein the operations further comprise:
determining a contribution level of a developer with respect to the target source code based on the similarity level of a source code snippet committed by the developer to the target source code and the generated score of the target source code.

11. The non-transitory machine-readable medium of claim 9, wherein:
the target source code is a method programmed to run a part of a particular function; and
the generating the score of the target source code further comprises generating the score of the target source code based on a frequency of a method call, a number of modifications to the method, a number of updates to the method, a measurable complexity metric of the method, or a combination thereof,
wherein the operations further comprise:
determining a contribution level of the target source code to the particular function based on the generated score of the target source code.

12. The non-transitory machine-readable medium of claim 9, wherein the operations further comprise:
determining the measurable complexity metric of the target source code based on labeled data using a supervised learning AI/ML model, wherein the labeled data comprise previously committed source code snippets and associated scores.

13. A method, comprising:
in a version control repository, storing, by a processing system including a processor, source code snippets committed by developers;
determining, by the processing system, a similarity level of every incoming source code snippet to each of the stored source code snippets;
maintaining, by the processing system, a code commit log that tracks the committing of the source code snippets along with a timestamp, the similarity level and a modification history for each source code snippet;
training, by the processing system, a supervised learning model with labeled data including previously committed source code snippets and associated scores;
extracting, by the processing system, a target source code from the code commit log;
determining a measurable complexity metric of the target source code based on a number of linearly independent paths in the target source code; and
using the trained supervised learning model, generating, by the processing system, a score of the target source code as an output of the trained supervised learning model based on a plurality of features as an input to the trained supervised learning model, wherein the plurality of features includes a call frequency of the target source code, a number of target source code modification, a number of target source code update, the measurable complexity metric of the target source code, or a combination thereof.

14. The method of claim 13, comprising:
determining, by the processing system, the measurable complexity metric of the target source code based on cyclomatic complexity using the trained supervised learning model.

15. The method of claim 13, comprising:
receiving, by the processing system, non-code contributions by developers;
differentiating, by the processing system, the non-code contributions from the source code snippets using the supervised learning model; and
assigning, by the processing system, different scoring values to the non-code contributions.

16. The method of claim 13, wherein:
the target source code is programmed to run a part of a particular function; and
wherein the method further comprises:
determining, by the processing system, a contribution level of the target source code to the particular function based on the generated score of the target source code.

17. The method of claim 16, further comprising:
determining and storing, by the processing system, expertise association between the particular function and a developer who has written the target source code.

18. The method of claim 16, wherein the determining the contribution level further comprises determining the contribution level of the target source code to the particular function by tracking a number of lines committed to program the particular function by each developer, and based on measurable complexity metric of the target source code and a rest of code programmed to run the particular function.

19. The method of claim 13, comprising:
extracting, by the processing system, a modification history of the target source code from the code commit log; and
using the supervised learning model, determining, by the processing system, a modification level of the target source code based on a modified part of the target source code, a modified type of the target source code, a nature of the modification history, or a combination thereof.

20. The method of claim 19, further comprising:
determining that the modified part of the target source code includes modifying core functionality;
determining that the modified type of the target source code includes modifying a new feature, fixing an error, refactoring, or a combination thereof; and
determining that the nature of modification includes a logic change, comments, logging or a combination thereof.
